(19) United States
(12) Patent Application Publication
(10) Pub. No.: US 2002/0159923 A1
(43) Pub. Date: Oct. 31, 2002

(54) Gas phase reactor and process for reducing nitrogen oxide in a gas stream

(76) Inventor: Erwin M.J. Platvoet, Jersey City, NJ (US)

Correspondence Address: Peter G. Dilworth, Dilworth & Barrese, LLP, 333 Earle Ovington Blvd., Uniondale, NY, 11553, US

(21) Appl. No.: 09/793,447

(22) Filed: Feb. 26, 2001

(51) Int. Cl. B01D 53/34; F01N 3/00

(52) U.S. Cl. 422/169; 422/168; 422/170; 422/171

(57) ABSTRACT

A gas phase reactor for the selective catalytic reduction of nitrogen oxide in a gas stream includes a shell enclosing an interior space in which is located at least one catalyst bed containing a catalyst for the selective conversion of NOₓ. An injector upstream of the catalyst introduces a reducing agent such as ammonia into the inlet gas stream. The catalyst bed can include particulate, monolith, or microengineered catalyst. A burner is employed to raise the temperature of the inlet gas stream. A heat exchanger is used to transfer heat from treated gas to the inlet gas. Optionally, a deflector is used to deflect gas flow through the heat exchanger.

### BACKGROUND OF THE INVENTION

1. Field of the Invention

The invention herein relates to a chemical reactor and method for catalytically reducing the content of nitrogen oxide in a gas, particularly flue or stack gas, resulting from the combustion of fuel.

2. Description of the Related Art

The combustion of fuels in various industrial processes often generates undesirable oxides of nitrogen (NOₓ), usually in the form of nitric oxide (NO) and nitrogen dioxide (NO₂). High combustion temperatures tend to produce more NOₓ. Because NOₓ is harmful to the environment, efforts have been made to reduce the emission of NOₓ. in gases produced by industrial processes involving the combustion of fuel, particularly gases resulting from the operation of power plants, thermal cracking furnaces, incinerators, internal combustion engines, metallurgical plants, fertilizer plants and chemical plants.

Methods for selectively reducing the NOₓ content of a flue gas are known. Generally, such methods involve the reaction of NOₓ with a reducing agent, optionally in the presence of a catalyst. The selective non-catalytic reduction (“SNCR”) of NOₓ with a reducing agent such as ammonia or urea requires a relatively high temperature, e.g., in the range of from about 1600° F. to about 2100° F.

Alternatively, the reduction of NOₓ with ammonia can be performed catalytically at a much lower temperature, e.g. from about 500° F. to about 950° F., in a process known as selective catalytic reduction (“SCR”).

One problem associated with the treatment of flue gas using conventional SCR methods and apparatus is that the weight and bulk of the equipment necessary to achieve satisfactory removal of NOₓ requires that it be located at ground level. Many industrial plants need to be retrofitted with NOₓ removal (“deNOx”) equipment in order to meet the requirements of more stringent government regulations. However, because of the physical bulk of the deNOx system, the flue gas must be diverted to ground level for treatment and then sent back into a stack for subsequent exhaust to the atmosphere. To avoid the large cost of such a system it would be highly advantageous to provide a relatively lightweight deNOx unit which can be incorporated directly into the stack.

### SUMMARY OF THE INVENTION

A gas phase reactor for the chemical conversion of nitrogen oxide in a gas stream is provided herein which comprises:

(a) a shell having interior and exterior surfaces, a proximal end, a distal end, and an axis defining a longitudinal direction, a gas stream inlet at the proximal end for receiving an inlet gas stream having an initial concentration of nitrogen oxide and a gas stream outlet through which treated gas of reduced nitrogen oxide concentration relative to the nitrogen oxide concentration of the inlet gas stream is discharged;

(b) an injector for introducing a reducing agent into the inlet gas stream;

(c) a burner positioned in the reactor shell for heating the inlet gas stream to a reaction temperature;

(d) a catalyst bed within the shell and positioned downstream of the burner, the catalyst bed containing at least one nitrogen oxide conversion catalyst for the selective catalytic reduction of nitrogen oxide in the inlet gas stream to provide a treated gas of reduced nitrogen oxide concentration; and,

(e) means positioned upstream of the burner for effecting heat exchange between the treated gas and the inlet gas stream containing reducing agent.

The reactor of this invention provides a relatively lightweight unit for the selective catalytic reduction of NOₓ in a gas, in particular flue gas produced by the combustion of a fossil fuel in a furnace, and is readily incorporated into furnaces equipped with stacks of conventional design, thus lending itself well to retrofit installation in existing units.

### BRIEF DESCRIPTION OF THE DRAWINGS

Various embodiments of the reactor of this invention and preferred catalyst arrangements employed therein are described below with reference to the drawings wherein:

FIG. 1A is a diagrammatic view of a furnace system of a known type incorporating the radial flow reactor of the present invention in its stack section;

FIG. 1B is a side view of FIG. 1A;

FIGS. 2A to 2I are diagrammatic illustrations of alternative embodiments of the reactors of the present invention;

FIGS. 3A and 3B are perspective and elevational views, respectively, of heat exchanger tubes useful in the reactors;

FIGS. 4A and 4B are, respectively, diagrammatic views of a cylindrical parallel flow catalyst bed and an annular radial flow catalyst bed;

FIG. 4C is a sectional view of a catalyst bed having particulate catalyst;

FIG. 5A illustrates a monolithic catalyst bed employing bricks;

FIG. 5B is a perspective view of a monolith brick;

FIGS. 5C and 5D illustrate alternative embodiments of monolith catalyst;

FIG. 6 is an isometric diagrammatic view of a packing structure useful for explaining the principles of the present invention;

FIG. 6A is a diagram useful for explaining parameters of a corrugated packing material;

FIG. 7 is a diagrammatic view of a combination of microengineered catalyst and monolith catalyst; and

FIG. 8 is an end view of a portion of a packing element.

### DETAILED DESCRIPTION OF PREFERRED EMBODIMENTS

As used herein the terms “stack” and “flue” are used synonymously. All quantities should be understood as being modified by the term “about” or “approximately”. Composition percentages are by weight unless specified otherwise. Like numerals indicate similar components.

The term “nitrogen oxide” as used herein refers to any oxide of nitrogen, such as NO, NO₂, N₂O₄, N₂O and any of their mixtures, and is alternatively designated “NOₓ”

The reactor and method for the selective catalytic reduction of NOₓ of this invention preferably employ ammonia as the reducing agent. NOₓ reacts with ammonia in the presence of catalyst to produce nitrogen and water as shown in the following equation (not stoichiometrically balanced):

NOₓ+NH₃→N₂+H₂O

The reactor and deNOx method described herein can be used in any application requiring the treatment of a NOₓ-containing gas to reduce its NOₓ level. Typical combustion equipment producing high levels of NOₓ include power plants, fluid catalytic cracking (FCC) regenerators, glass furnaces, thermal crackers, and the like. The deNOx method herein will be particularly described in conjunction with a thermal cracking unit for producing olefins (e.g., ethylene, propylene, butylene, etc.) from a saturated hydrocarbon feedstock such as ethane, propane, naphtha, and the like. However, the reactor and method can be used with any combustion equipment or process which generates a gas containing undesirable levels of NOₓ.

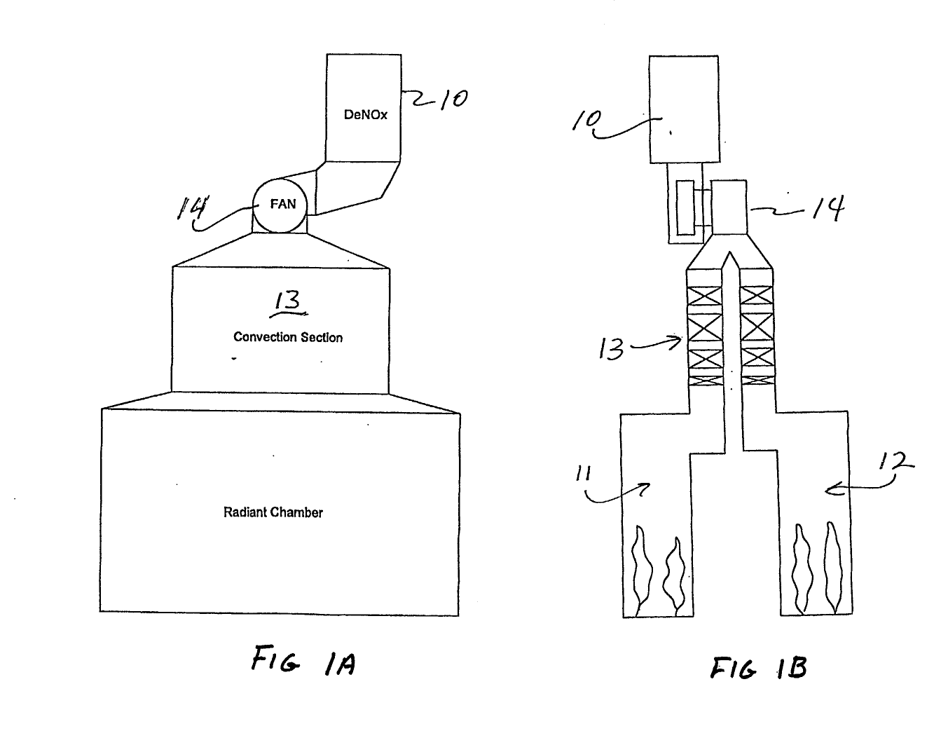

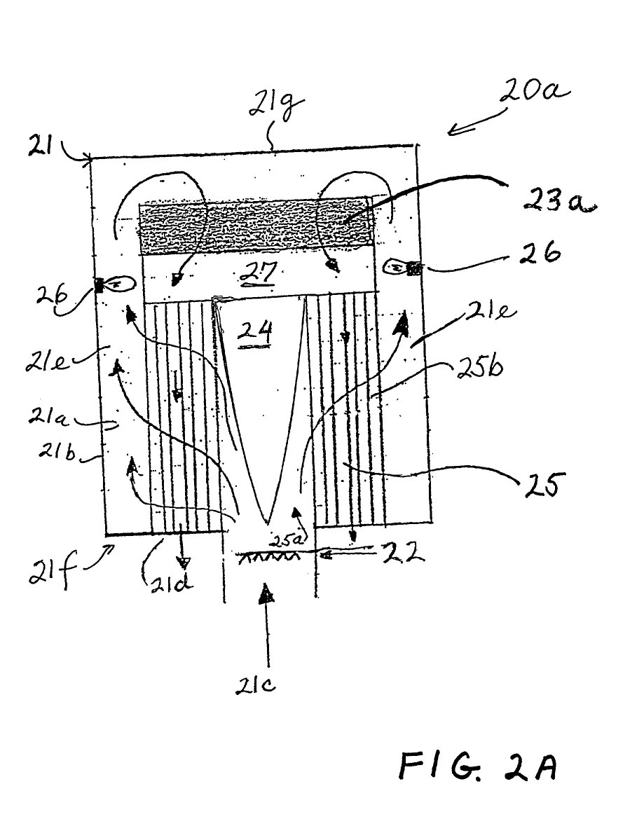

Referring now to FIGS. 1A and 1B, gas phase deNOx reactor 10 is illustrated in conjunction with a thermal cracking system employing twin furnaces 11 and 12 having a radiant combustion chamber operating at about 2200° F. for the cracking of the feedstock. Each furnace produces a flue gas which exits therefrom through respective stacks. Typically, the flow rate of flue gas in each stack ranges from about 100,000-300,000 lbs/hr. The flue gas typically contains the following components:

| | | |
|---|---|---|
| Nitrogen | 60-80 | vol % |
| Oxygen | 1-4 | vol % |
| Water vapor | 10-25 | vol % |
| Carbon dioxide | 2-20 | vol % |
| Nitrogen oxide | 50-300 | ppm. |

The flue gases exiting the radiant chamber are typically at a temperature of about 1800° F. Each stack optionally includes a convection section 13 which includes heat exchange equipment through which the flue gas is passed for heat recovery. The flue gas typically exits the convection section at a temperature of from about 300° F.-500F., although the heat recovery process can be adjusted to provide flue gas temperatures outside this range. The flue gases of the separate stacks are then joined and moved by fan 14 into deNOx system 10. Fan 14 increases the pressure of the flue gas for moving the gas through the deNOx system 10.

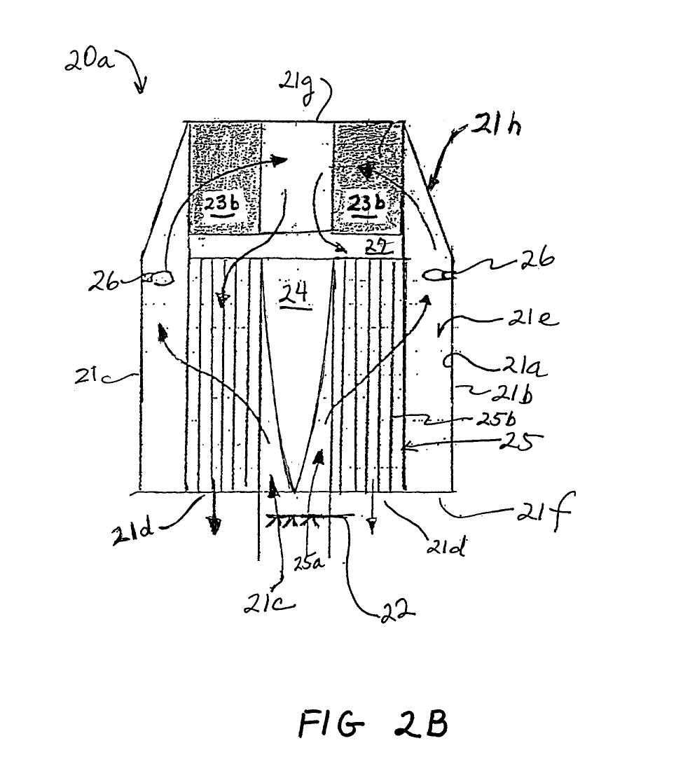

Referring now to FIG. 2, in one embodiment, gas phase reactor 20a includes a reactor shell 21 having an interior surface 21a and exterior surface 21b. Shell 21 includes a gas stream inlet 21c at the proximal end 21f of the shell through which inlet gas containing an initial concentration of NOₓ is received, and a gas stream outlet 21d through which treated gas containing a reduced concentration of NOₓ is discharged. The gas stream outlet 21d may optionally be positioned at the proximal end 21f or the distal end 21g of the shell.

Injector 22 can be any type of injector known in the art for introducing a reducing agent. Typically, such injectors include a grid-like portion positioned in the inlet gas stream upstream of the catalyst bed. The grid-like portion includes a collection of sparger tubes with injection nozzles arranged in an evenly distributed manner. Generally, the reducing agent is injected in a direction opposite that of the flow of inlet gas. The reducing agent is preferably ammonia but may alternatively be, or additionally include, urea, an alkyl amine or other suitable reducing agent. Injector 22 can be positioned within the inlet 21c or upstream of the inlet 21c.

The catalyst bed contains at least one catalyst for the selective reduction of nitrogen oxide. The preferred temperature for the selective catalytic reduction reaction will typically range from about 380° F. to about 550° F., more preferably from about 400° F. to 450° F. Generally, the lower the temperature, the greater amount of catalyst is required to achieve a predetermined level of NOₓ conversion. In cases where the flue gas temperature is undesirably low, a burner or other source of heat can be used to increase the flue gas temperature. Alternatively, convection section 13 of the furnace system can be configured to provide a flue gas having a temperature suitable for selective catalytic reduction of NOₓ.

Catalysts for the selective reduction of nitrogen oxides in the presence of reducing agent are known in the art. Representative examples of such catalysts include, but are not limited to, oxides of vanadium, aluminum, titanium, tungsten and molybdenum. Zeolites can also be used. Examples of the latter include ZSM-5 modified with protons, or with copper, cobalt, silver, zinc, or platinum cations or their combinations. It is to be understood, however, that the scope of the present invention is not limited to a specific SCR catalyst or catalyst composition.

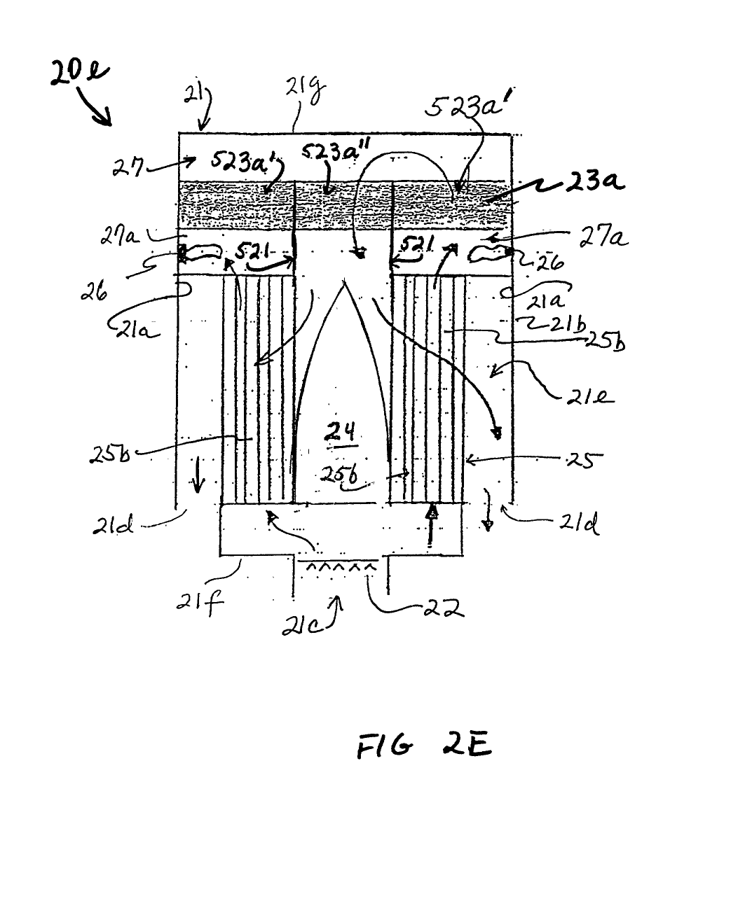

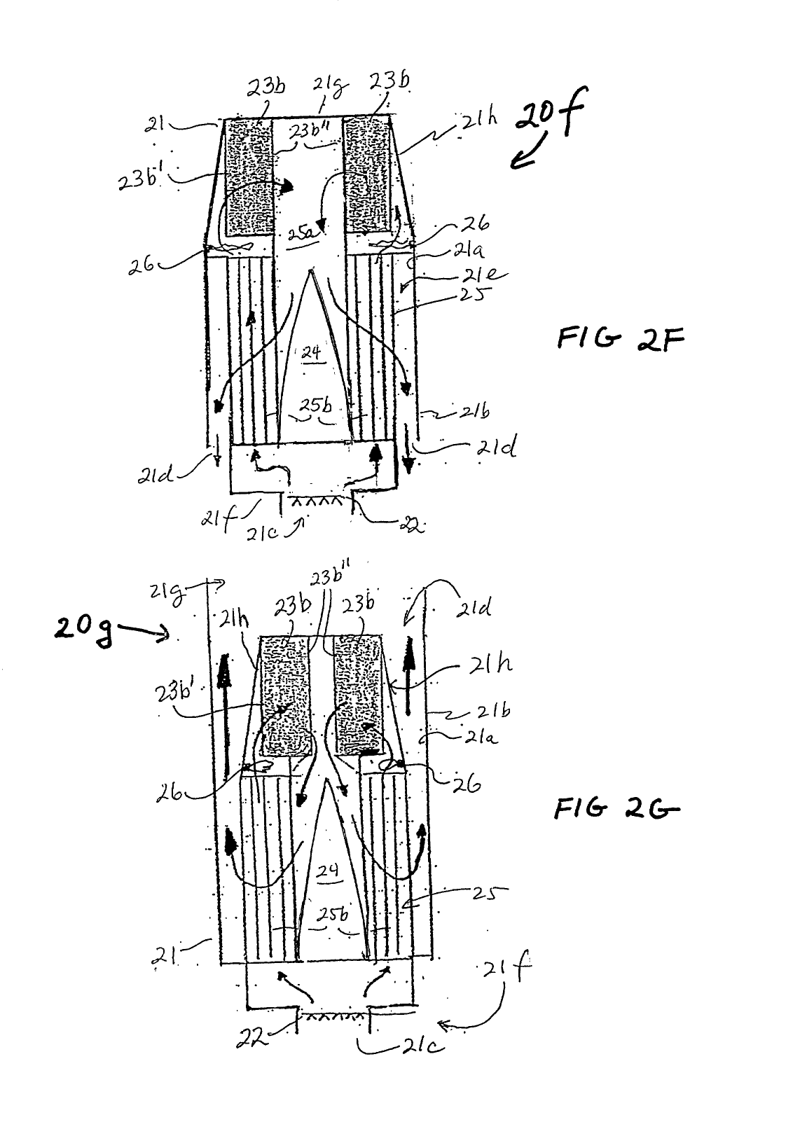

Referring to FIGS. 4A and 4B, the catalyst bed can be in the form of a cylinder 23a or an annulus 23b. When a cylindrical catalyst bed 23a is employed, the gas flow through the bed is axial flow, e.g. from upper wall 23a′ to lower wall 23a″. When an annular bed 23b is used, the gas flow through the bed is radial, e.g. from outer wall 23b′ to inner wall 23b″. While beds 23a and 23b are shown as having a round circumferential periphery, it should be noted that other shapes can also be used. For example, catalyst beds 23a and 23b can be rectangular plates, or can have polygonal shapes such as octagonal, hexagonal etc.

Referring again to FIG. 2A, the catalyst bed for reactor 20a is an axial flow bed 23a. The reactor 20 includes a radial flow heat exchanger 25 having an axial opening 25a in which deflector 24 is disposed with an apex pointing proximally and upstream. Deflector 24 preferably has a parabolic contour. The deflector 24 is fabricated from a gas-impervious material such as sheet metal and directs the inlet gas radially outward across the tubes 25b of the heat exchanger.

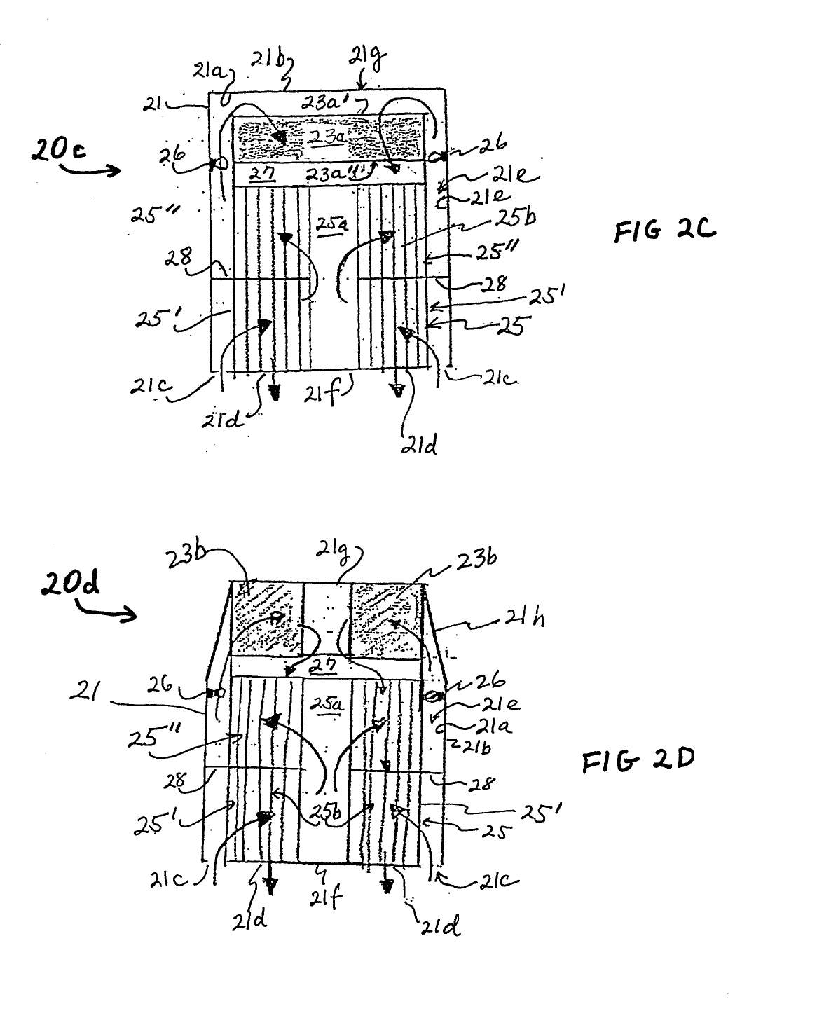

Referring to FIGS. 3A and 3B, the tubes 25b of the heat exchanger preferably have fins 25c extending outward from the surface of the tubes to facilitate heat transfer between the fluid flowing through the bore 25d of the tubes 25b and the fluid flowing across the tubes 25b. Heat exchanger tubes suitable for use in the present invention are known and commercially available from various suppliers such as TPS-Technitube Rohrenwerke Gmbh of Daun, Germany.

Reactor 20a further includes one or more burners 26 downstream of the heat exchanger 25 and upstream of the catalyst bed 23a to increase the temperature of the inlet gas stream prior to passing through the catalyst bed. Plenum chamber 27 is positioned adjacent the catalyst bed 23a to prevent disparities in gas pressure. As can be seen, inlet gas enters reactor 20a through inlet 21c and is mixed with reducing agent as it passes injector grid 22. The inlet gas with reducing agent enters the axial opening 25a of the heat exchanger and is directed radially outward across the tubes of the heat exchanger by deflector 24. Unnumbered arrows in the drawings illustrate the direction of gas flow. The inlet gas stream with reducing agent is warmed by heat recovered from the treated gas which flows through the bores of the tubes. The treated gas with reducing agent exits the periphery of the heat exchanger 25 and flows through annular space 21e between the outer periphery of the heat exchanger and inner surface 21a of the reactor shell. The inlet gas with reducing agent flows distally whereupon it is heated by one or more burners 26 to a suitable reaction temperature. The inlet gas with reducing agent is then directed around and enters the distal side of catalyst bed 23a whereupon it flows proximally through catalyst bed 23a as an axial flow. The treated gas emerging from the proximal side of catalyst bed 23a then enters plenum chamber 27 to even out the gas pressure across the cross section of the reactor, and then flows proximally through the tubes 25b of the heat exchanger 25 where it transfers heat to the inlet gas stream. Treated gas exits the reactor proximally through outlet 21d.

Referring now to FIG. 2B, an alternative embodiment 20b of the reactor is similar to embodiment 20a described above with similar components except that the catalyst bed is an annular bed 23b. Reactor 20b is a radial flow reactor wherein, after passing one or more burners 26 for supplemental heating, the inlet gas with the reducing agent enters the catalyst bed through peripheral wall 23b′ and exits the catalyst bed as treated gas through inner wall 23b″. The treated gas then enters plenum 27 and thereafter passes through bores 25d of the tubes 25b to transfer heat to the inlet gas passing radially outward through the heat exchanger 25 and laterally across the outside of the tubes. Optionally, reactor 20b can include a specifically shaped portion 21h of the shell to provide for a more even pressure distribution of the inlet gas with reducing agent entering the catalyst bed 25b.

Referring now to FIG. 2C, an alternative embodiment 20c of the reactor includes one or more gas stream inlets 21c positioned outside of the periphery of the heat exchanger 25. The injector 22 (not shown) is upstream of the gas stream inlet. Reactor 20c includes a baffle plate 28 extending laterally across the heat exchanger tubes 25b thereby dividing the heat exchanger into a proximal heat exchanger portion 25′ and a distal heat exchanger portion 25″. The baffle plate extends to the inner surface 21a of the shell but not into the axial opening 25a of the heat exchanger. Accordingly, upon entering through inlet 21c, the inlet gas stream with reducing agent travels radially inward through the proximal portion 25′ of the heat exchanger into axial opening 25a and thereafter radially outward through distal portion 25′ of the heat exchanger, whereupon it enters into space 21e between the exterior of the heat exchanger and the interior surface 21a of the shell, then passes one or more burners 26 for supplemental heating. The inlet gas with reducing agent enters cylindrical catalyst bed 23a through distal surface 23a′ and emerges as treated gas through proximal surface 23a″ into plenum 27. From plenum 27, the treated gas enters the bores 25d of the heat exchanger tubes 25b and thereupon transfers heat to the inlet gas passing laterally across the tubes. The treated gas exits the reactor at a proximal outlet 21d.

Referring now to FIG. 2D, an alternative embodiment 20d of the reactor is similar to embodiment 20c described above with similar components except that the catalyst bed is an annular bed 23b. Reactor 20d employs a radial flow catalyst bed wherein after passing burners 26 for supplemental heating the inlet gas with the reducing agent enters the catalyst bed 23b through peripheral wall 23b′ and exits the catalyst bed as treated gas through inner wall 23b″. The treated gas then enters plenum 27 and thereafter passes through bores 25d of tubes 25b to transfer heat to the inlet gas passing radially outward through the heat exchanger 25 laterally across the outside of the tubes. Optionally, reactor 20d can include a specifically shaped portion 21h of the shell to provide for a more even pressure distribution of the inlet gas with reducing agent entering the catalyst bed 23b.

Referring now to FIG. 2E, an alternative embodiment 20e of the reactor includes a gas stream inlet 21c which provides for entry of the inlet gas with reducing agent into the bores 25d of tubes 25a of heat exchanger 25. The inlet gas with reducing agent thereafter enters chamber 27a which is at least partially defined by cylindrical wall 521 and the inner surface 21a of the shell, whereupon the inlet gas stream with reducing agent is heated by one or more burners 26. Cylindrical wall 521 extends into catalyst bed 23a and divides the catalyst bed into two sections: an annular section 523a′ and an axial section 523a″.

The inlet gas with reducing agent enters the proximal end of the annular section 523a′ of the catalyst bed, then exits through the distal surface of annular section and enters plenum 27 which is distal to, and adjacent to, catalyst bed 23a. The gas stream thereafter enters the distal end of axial section 523a″ of the catalyst bed, and, moving proximally, exits as treated gas from the proximal end of section 523a″ of the bed and enters axial opening 25a of heat exchanger 25. A conical deflector 24 is positioned within the axial opening 25a with a distally pointing apex. Deflector 24 provides for the directing of treated gas radially outward through the heat exchanger where it transfers heat to the inlet gas stream flowing through the heat exchanger tubes. The treated gas then enters the annular space 21e between the outer periphery of the heat exchanger and the inner surface 21a of the shell, and then exits the reactor proximally through outlet 21d.

Referring now to FIG. 2F, an alternative embodiment 20f of the reactor is similar to the embodiment 20e described above with similar components except that the catalyst bed is an annular bed 23b. Reactor 20e is a radial flow reactor wherein after passing burners 26 for supplemental heating, the inlet gas with reducing agent enters the catalyst bed 23b through peripheral wall 23b′ and exits the catalyst bed 23b as treated gas through inner wall 23b″. The treated gas then enters axial opening 25a of the heat exchanger, is deflected radially outward across the heat exchanger tubes 25b to preheat the inlet gas and then exits the reactor through proximal outlet 21d. Optionally, reactor 20f can include a shaped portion 21h of the shell to provide for a more even pressure distribution of the inlet gas with reducing agent entering the catalyst bed 23b.

Referring now to FIG. 2G, an alternative embodiment 20g of the reactor is similar to the embodiment 20f except that the treated gas exiting the heat exchanger into the space 21e between the outer periphery of the heat exchanger and the inner surface 21a of the shell flows distally to a distal outlet 21d of the reactor.

Referring now to FIG. 2H, an alternative embodiment 20h of the reactor one or more gas stream inlets 21c for providing a passageway through which inlet gas stream with reducing agent enters the bores 25d of the heat exchanger tubes. The injector 22 (not shown) is positioned upstream of the gas to stream inlet 21c. The inlet gas stream with reducing agent flows longitudinally through the heat exchanger 25 where it is preheated by treated gas. Upon exiting the heat exchanger, the inlet gas enters chamber 27a which is at least partially defined by cylindrical wall 521 and the inner surface 21a of the shell, whereupon the inlet gas stream is reducing agent is heated by one or more burners 26. Cylindrical wall 521 extends into catalyst bed 23a and divides the catalyst bed into two sections: an annular section 523a′ and an axial section 523a″.

The inlet gas with reducing agent enters the proximal end of the annular section 523a′ of the catalyst bed, then exits through the distal surface of annular section and enters plenum 27 which is distal to, and adjacent to, catalyst bed 23a. The gas stream thereafter enters the distal end of axial section 523a″ of the catalyst bed, and, moving proximally, exits as treated gas from the proximal end of section 523a″ of the bed and enters axial opening 25a of heat exchanger 25. A baffle plate 28 extends laterally across the axial opening 25a of the heat exchanger and the heat exchanger tubes thereby dividing the heat exchanger into a proximal heat exchanger portion 25′ and a distal heat exchanger portion 25″. The baffle plate 28 does not extend into the space 21e between the outer periphery of the heat exchanger and the inner surface 21a of the shell. Accordingly, upon exiting the proximal end of section 523a″ and entering axial opening 25a of the heat exchanger, the treated gas is deflected by baffle plate 28 so as to move radially outward through the distal section 25″ of the heat exchanger into space 21e and then moves radially inward through the proximal section 25′ of the heat exchanger. The treated gas then exits the reactor through proximal axial outlet 21d.

Referring now to FIG. 2I, an alternative embodiment 20i of the reactor is similar to the embodiment 20h described above with similar components except that the catalyst bed is an annular bed 23b. Reactor 20i is a radial flow reactor wherein after passing burners 26 for supplemental heating, the inlet gas with reducing agent enters the catalyst bed 23b through peripheral wall 23b′ and exits the catalyst bed 23b as treated gas through inner wall 23b″. The treated gas then enters axial opening 25a of the heat exchanger, is deflected radially outward across the heat exchanger tubes 25b by baffle plate 28 to preheat the inlet gas and then exits the reactor through axial proximal outlet 21d. Optionally, reactor 20i can include a shaped portion 21h of the shell to provide for a more even pressure distribution of the inlet gas with reducing agent entering the catalyst bed 23b.

The catalyst can be in the form of particulate, monolith, or microengineered catalyst (“MEC”).

Referring to FIG. 4C, catalyst bed 23a contains particulate catalyst 23c enclosed within a screen periphery 23d. The screen 23d is commercially available from USF/Johnson Screens of Wytheville, Va. Suitable screens include, e.g., welded wire screens, looped wire screens and woven wire screens. The SCR catalyst can be in the form of particulate, or can be supported on a particulate catalyst support such as titania, zeolite, carbon, zirconia, ceramic or silica-alumina.

Annular catalyst bed 23b can also include particulate catalyst and can also include peripheral walls 23b′ and 23b″ fabricated from screens.

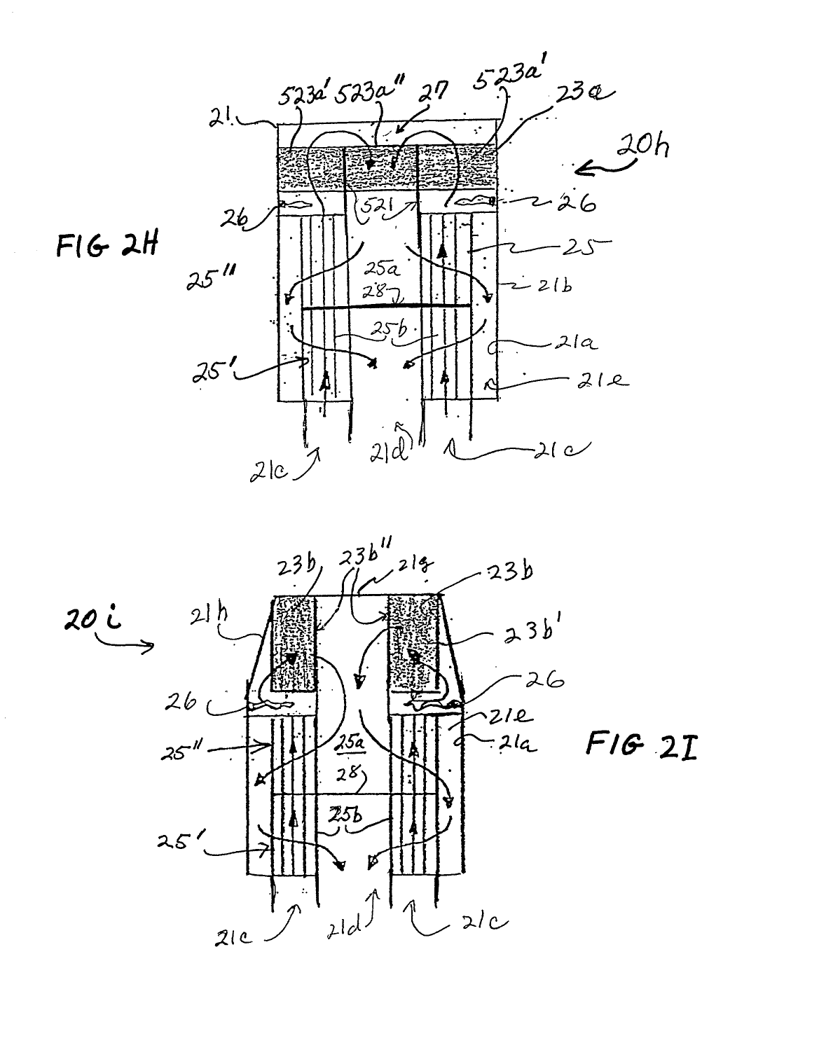

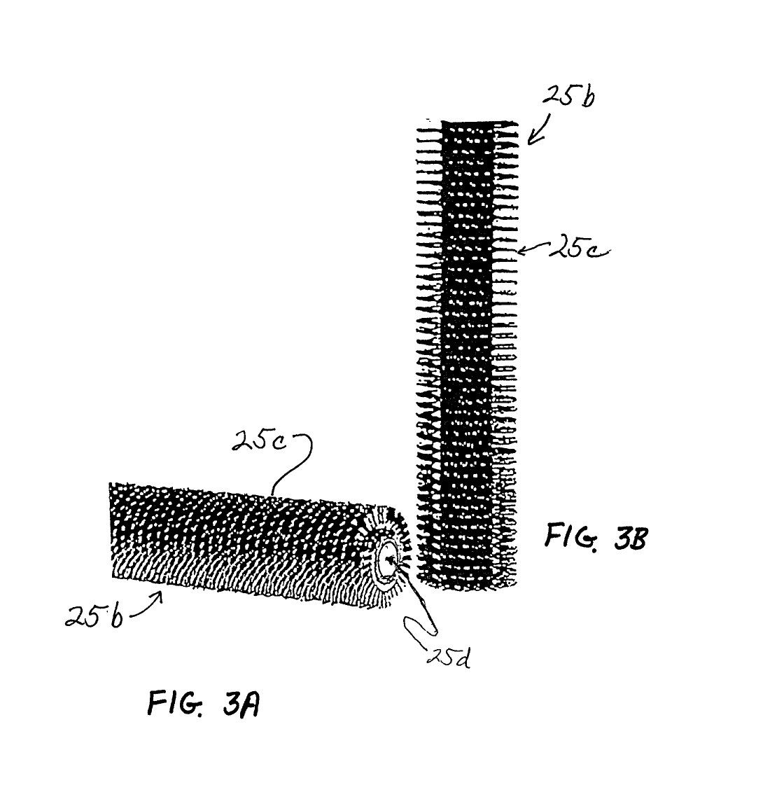

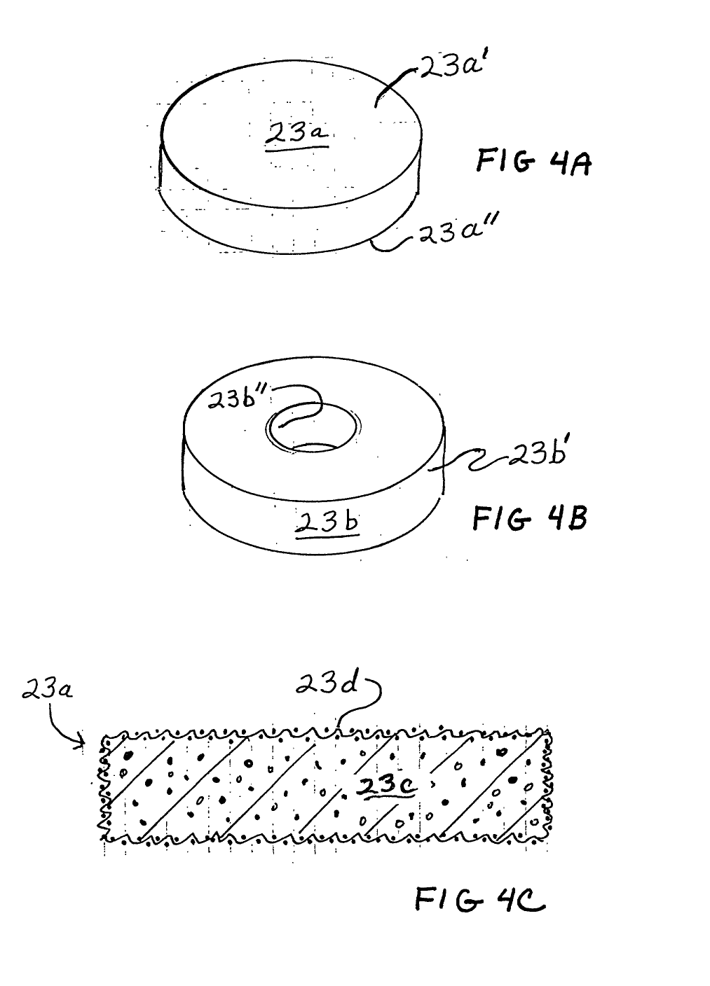

Referring now to FIGS. 5A-5D, the catalyst can be in the form of monolith 50 which can include a plurality of stacked blocks 51. The monolith catalyst 50 includes a plurality of parallel channels. As shown in FIG. 5c, monolith 52 possesses a honeycomb structure with hexagonal channels 53. The channels, however, can be of any suitable shape such as square, triangular, T-shapes, and the like. FIG. 5D illustrates a monolith 54 having circular channels 55. The monoliths can be formed by sintering or any other method known to those with skill in the art. Typically, the SCR catalyst is impregnated into the monolith support so as to coat the inner surface of the channels through which the gas stream flows for treatment.

In yet another alternative, the catalyst bed can include a microengineered catalyst (“MEC”) wherein the SCR catalyst is supported on a mesh-like structure having a porosity greater than about 85%. The MEC catalyst is described in copending U.S. patent application Ser. No. ______ filed Jul. 31, 2000 under Attorney Docket No. 415000-530, the contents of which are herein incorporated by reference in their entirety.

The mesh-like material is comprised of fibers or wires, such as a wire or fiber mesh, a metal felt or gauze, metal fiber filter or the like. The mesh-like structure can be comprised of a single layer, or can include more than one layer of wires: e.g., a knitted wire structure or a woven wire structure, and preferably is comprised of a plurality of layers of wires or fibers to form a three-dimensional network of materials. In a preferred embodiment, the support structure is comprised of a plurality of layers of fibers that are oriented randomly in the layers. One or more metals can be used in producing a metal mesh. Alternatively, the mesh fibers can include materials in addition to metals.

In a preferred embodiment wherein the mesh-like structure is comprised of a plurality of layers of fibers to form the three-dimensional network of materials, the thickness of such support is at least five microns, and generally does not exceed ten millimeters. In accordance with a preferred embodiment, the thickness of the network is at least 50 microns and more preferably at least 100 microns and generally does not exceed 2 millimeters.

In general, the thickness or diameter of the fibers which form the plurality of layers of fibers is less than about 500 microns, preferably less than about 150 microns and more preferably less than about 30 microns. In a preferred embodiment, the thickness or diameter of the fibers is from about 8 to about 25 microns.

The three dimensional mesh-like structure can be produced by known methods such as any of those described in U.S. Pat. Nos. 5,304,330, 5,080,962; 5,102,745 or 5,096,663, the contents of which are incorporated by reference in their entirety. It is to be understood, however, that such mesh-like structure can be formed by procedures other than those described in the aforementioned patents.

The mesh-like structure that is employed in the present invention (without supported catalyst on the mesh) has a porosity or void volume which is greater than 85%, and preferably is greater than 87% and more preferably is greater than 90%. The term “void volume” as used herein is determined by dividing the volume of the structure which is open by the total volume of the structure (openings and mesh material) and multiplying by 100.

In one embodiment, the catalyst is supported on the mesh-like material without the use of a particulate support.

In another embodiment, the catalyst for converting nitrogen oxide(s) is supported on a particulate support that is supported on the mesh-like material. The term “particulate” as used herein includes, and encompasses, spherical particles, elongated particles, fibers, etc. In general, the average particle size of the particulate on which catalyst may be supported does not exceed 200 microns and is typically no greater than 50 microns with the average particle size in the majority of cases not exceeding 20 microns. In general, the average particle size of such particulates is at least 0.002 micron and more generally at least 0.5 microns. When the catalyst supported on the particulate support is coated on the mesh, the average particle size of the catalyst support generally does not exceed 10 microns and, when entrapped in the mesh, generally does not exceed 150 microns.

In an embodiment of the invention, the mesh-like structure that functions as a support for the catalyst is in the form of a shaped structured packing. This packing can be configured as described below in embodiments given by example to provide for turbulence of the gas phase flowing over the catalyst in the reactor. The mesh-like catalyst support structure can be provided with suitable corrugations in order to provide for increased turbulence as described in more detail hereinafter. Alternatively, the mesh-like structure can include tabs or vortex generators to provide for turbulence, also as shown hereinafter. The presence of turbulence generators enhances mixing in the radial (and longitudinal) direction and also improves access to catalyst either coated on or entrapped in the mesh by providing local pressure differential across the mesh, and thus creating a driving force for flow. The structured packing can also be in the form of a module such as a roll of one or more sheets that is placed into the tubes of a reactor such that the channels in the module follow the longitudinal direction of the tube. The roll can comprise sheets that are flat, corrugated or wavy or a combination thereof and the sheets can contain fins or holes to promote mixing. The sheets can also be shaped into corrugated strips that are separated from each other by a flat sheet that exactly fit the size of the tube and are held together by welds, wires, a cylindrical flat sheet or combinations thereof.

It is to be understood that the mesh-like support that supports the catalyst may be employed in a form other than as a structured sheet. For example, the mesh-like support may be formed as rings, particles, ribbons, etc. and employed in a reactor as a packed bed.

The catalyst which is supported on the mesh-like structure can be present on the mesh-like support as a coating on the wires or fibers that form the mesh-like structure and/or can be present and retained in the interstices of the mesh-like structure.

The catalyst can be coated on the mesh-like structure by a variety of techniques, e.g., dipping or spraying. The catalyst particles can be applied to the mesh-like structure by contacting the mesh-like structure with a liquid coating composition (preferably in the form of a coating bath) that includes the particles dispersed in a liquid under conditions such that the coating composition enters or wicks into the mesh-like structure and forms a porous coating on both the interior and exterior portions of the mesh-like structure.

The catalyst is supported on the mesh-like structure in an amount effective to convert nitrogen oxide(s). In general, the catalyst is present in an amount of at least 5%, and preferably at least 10%, with the amount of catalyst generally not exceeding 60% and more generally not exceeding 40%, all by weight, based on mesh and catalyst. In one embodiment where the porosity or void volume of the mesh-like structure prior to adding supported catalyst is greater than 87%, the weight percent of catalyst is from about 5% to about 40%, and when the porosity or void volume is greater than 90%, the weight percent of supported catalyst is from about 5% to about 80%.

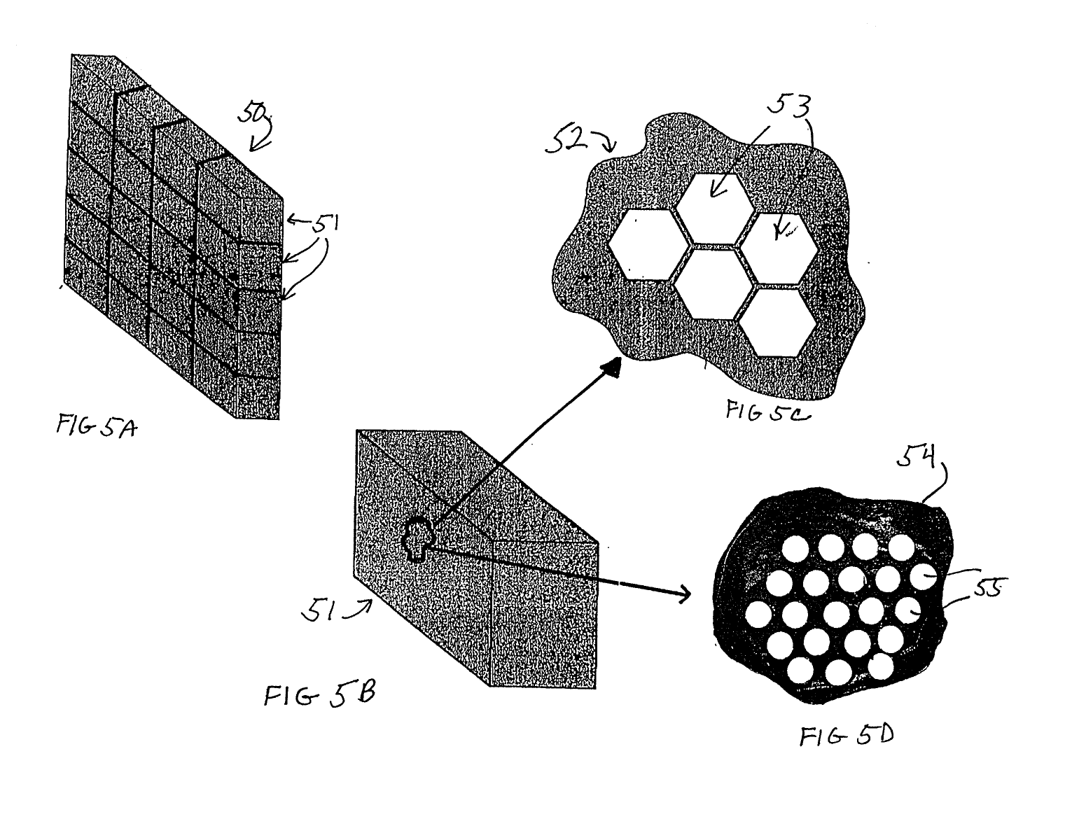

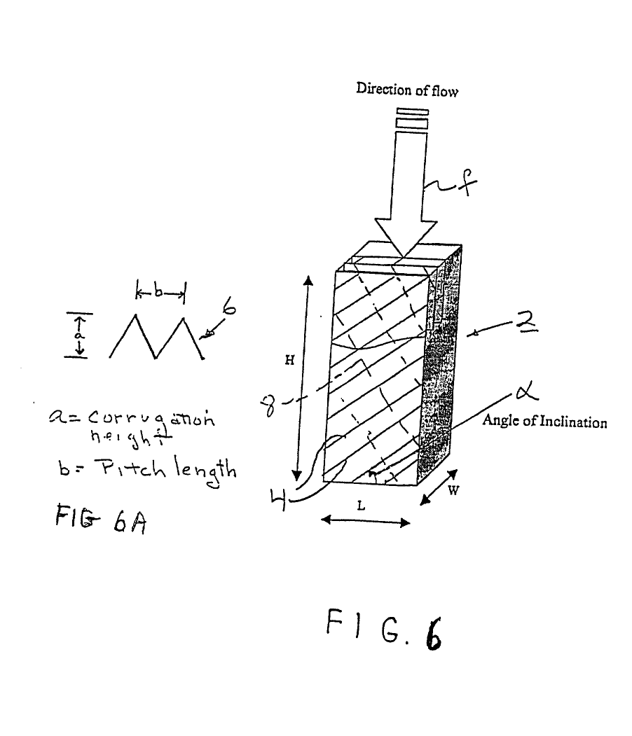

Various embodiments of structural packings will now be described. In FIG. 6, packing 2 is diagrammatically representative of a plurality of parallel corrugated sheets of porous mesh material (referred to herein as MEC material) in which the corrugations 4 are represented by diagonal lines which are at an angle α to the vertical direction of flow f. FIG. 6A, a representative cross section of a corrugation 6. Adjacent corrugated sheets 8 alternate 90° from each other.

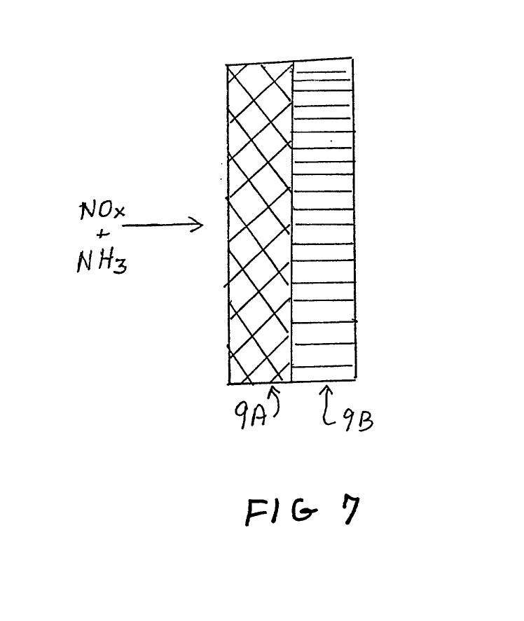

In FIG. 7, a conventional monolith honeycomb structure 9B is combined with MEC mesh material 9A of the present invention for providing a combined catalyst bed structure for the SCR conversion of NOₓ. The combined structure provides improved conversion. The increase in conversion is believed to be caused by the improved mixing of the structure creating an improved efficiency of the downstream honeycomb monolith.

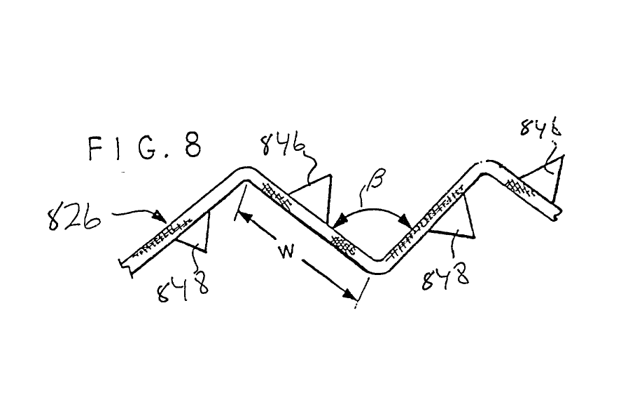

Referring to FIG. 8, the MEC mesh material can be fabricated from elements 826 of sheet material and can optionally include vortex generators for increasing turbulence of the gas flow therethrough. In FIG. 8, optional vortex generators 846 and 848 are triangular and bent from the plane of the element 826 sheet material. The generators 846 and 848 alternate in the direction in which they project from the plane of the sheet material as best seen in FIG. 8. The corrugations have a width w. By providing additional turbulence, the vortex generators further promote fluid flow through the pores of the MEC material due to the pressure differential thereacross. The side walls of element 826 are inclined at an angle β of about 90 °. The roots and crests extend in a linear direction.

The following Example illustrates the operation of the reactor of the present invention and method for the selective catalytic reduction of NOₓ in a gas stream.

### EXAMPLE

A gas phase reactor shown in FIG. 2C is employed for the selective catalytic reduction of NOₓ in the combined flue gas of two furnaces under the following flue gas conditions:

Flow rate=360,000 lbs/hr.

Temperature of flue gas=360 ° F. (182° C.)

NOₓ content=100 ppm.

A sufficient amount of ammonia is added to the flue gas to achieve the desired reduction of NOₓ. The catalyst employed is MEC coated with V₂O₅/TIO₂ catalyst. To achieve a desired NOₓ reduction of 90% to 10 ppm at a flue gas temperature of 360° F. would require 54 m³ of catalyst. However, by employing the reactor and method of the present invention, the selective catalytic reduction reaction in the catalyst bed takes place at 420° F. and the required catalyst volume is only 12 m³, which is less than 25% of the weight and volume of catalyst required at an operating temperature of 360° F.

More particularly, the heat exchanger employed in the reactor of FIG. 2C employs 2 inch diameter tubes with 1 inch high radial steel fins. The tube length is 6 meters and the outside diameter of the tube bundle is 4 meters. A baffle plate is employed to provide a 2 pass flow of gas across the heat exchanger. The inlet flue gas containing ammonia enters the heat exchanger at 360° F. and exits the heat exchanger at 400° F. The flue gas with ammonia is then heated by one or more burners to a desired reaction temperature of 420° F. The gas maintains the temperature of 420° F. while passing through the catalyst bed. The treated gas is then passed through the heat exchanger to transfer heat to the inlet flue gas and is cooled from 420° F. to 380° F.

The efficiency loss in the system is the difference between the outlet temperature of 380° F. and the original inlet temperature of 360° F. However, the 75% reduction of weight and volume of the catalyst bed provides a relatively lightweight unit for the selective catalytic reduction of NOₓ which can be readily installed by retrofitting into existing furnace systems.

While the above description contains many specifics, these specifics should not be construed as limitations on the scope of the invention, but merely as exemplifications of preferred embodiments thereof. Those skilled in the art will envision many other possibilities within the scope and spirit of the invention as defined by the claims appended hereto.

What is claimed is:

1. A gas phase reactor for the chemical conversion of nitrogen oxide in a gas stream which comprises:
a) a shell having interior and exterior surfaces, a proximal end, a distal end, and an axis defining a longitudinal direction, a gas stream inlet at the proximal end for receiving an inlet gas stream having an initial concentration of nitrogen oxide and a gas stream outlet through which treated gas of reduced nitrogen oxide concentration relative to the nitrogen oxide concentration of the inlet gas stream is discharged;
b) an injector for introducing a reducing agent into the inlet gas stream;
c) a burner positioned in the reactor shell for heating the inlet gas stream to a reaction temperature;
d) a catalyst bed within the shell and positioned downstream of the burner, the catalyst bed containing at least one nitrogen oxide conversion catalyst for the selective catalytic reduction of nitrogen oxide in the inlet gas stream to provide a treated gas of reduced nitrogen oxide concentration; and,
e) means positioned upstream of the burner for effecting heat exchange between the treated gas and the inlet gas stream containing reducing agent.

2. The reactor of claim 1 wherein the injector is an injector grid positioned upstream of the gas stream inlet.

3. The reactor of claim 1 further including a fan for increasing the pressure of the inlet gas stream within the reactor shell.

4. The reactor of claim 1 wherein the means for effecting heat exchange is a heat exchanger positioned proximal to the catalyst bed and having a plurality of spaced apart longitudinally oriented tubes arranged in a bundle, the bundle having an axial passageway, wherein the bundle has an outer periphery spaced apart from the inner surface of the reactor shell and defining therewith an annular passage.

5. The reactor of claim 4 further including a deflector positioned within the axial passageway of the heat exchanger for directing gas flow radially through the heat exchanger across the bundle of tubes.

6. The reactor of claim 5 wherein the deflector is conically shaped having a proximally pointing apex.

7. The reactor of claim 5 wherein the deflector is conically shaped having a distally pointing apex.

8. The reactor of claim 1 wherein the outlet is at the proximal end of the reactor shell.

9. The reactor of claim 1 wherein the outlet is at the distal end of the reactor shell.

10. The reactor of claim 4 wherein the burner is downstream of the heat exchanger.

11. The reactor of claim 1 wherein the catalyst bed has a cylindrical configuration.

12. The reactor of claim 1 wherein the catalyst bed has an annular configuration.

13. The reactor of claim 4 wherein the heat exchanger includes a baffle extending laterally across the bundle of tubes.

14. The reactor of claim 1 wherein the catalyst bed is downstream of, and distal to, the burner.

15. The reactor of claim 1 further including a plenum chamber adjacent to the catalyst bed.

16. The reactor of claim 4 further including a gas deflector positioned within the axial passageway of the heat exchanger, the gas deflector being conically shaped and having a proximally pointing apex, wherein the catalyst bed has a cylindrical configuration and wherein the reactor further includes a plenum chamber adjacent to and proximal to the catalyst bed.

17. The reactor of claim 4 further including a gas deflector positioned within the axial passageway of the heat exchanger, the gas deflector being conically shaped and having a proximally pointing apex, wherein the catalyst bed has an annular configuration and has an inner surface defining an axial bore for conveying treated gas.

18. The reactor of claim 4 further including a baffle plate extending laterally across the bundle of tubes and across the annular passage, the baffle plate defining a distal heat exchanger portion and a proximal heat exchanger portion, wherein the catalyst bed has a cylindrical configuration.

19. The reactor of claim 4 further including a baffle plate extending laterally across the bundle of tubes and across the annular passage, the baffle plate defining a distal heat exchanger portion and a proximal heat exchanger portion, wherein the catalyst bed has an annular configuration.

20. The reactor of claim 4 further including a gas deflector positioned within the axial passageway of the heat exchanger, the gas deflector being conically shaped and having a distally pointing apex, wherein the catalyst bed has a cylindrical configuration and wherein the reactor further includes a plenum chamber adjacent to and distal to the catalyst bed.

21. The reactor of claim 4 further including a gas deflector positioned within the axial passageway of the heat exchanger, the gas deflector being conically shaped and having a distally pointing apex, wherein the catalyst bed has an annular configuration and has an inner surface defining an axial bore for conveying treated gas, and wherein the gas stream outlet is at the proximal end of the shell.

22. The reactor of claim 4 further including a gas deflector positioned within the axial passage of the heat exchanger, the gas deflector being conically shaped and having a distally pointing apex, wherein the catalyst bed has an annular configuration and has an inner surface defining an axial bore for conveying treated gas, and wherein the gas stream outlet is at the distal end of the shell.

23. The reactor of claim 4 further including a baffle plate extending laterally across the bundle of tubes and across the axial passageway of the heat exchanger, the baffle plate defining a distal heat exchanger portion and a proximal heat exchanger portion, wherein the catalyst bed has a cylindrical configuration.

24. The reactor of claim 4 further including a baffle plate extending laterally across the bundle of tubes and across the axial passageway of the heat exchanger, the baffle plate defining a distal heat exchanger portion and a proximal heat exchanger portion, wherein the catalyst bed has an annular configuration.

25. The reactor of claim 1 wherein the catalyst bed includes particulate.

26. The reactor of claim 1 wherein the catalyst bed is a monolith.

27. The reactor of claim 1 wherein the catalyst is supported on a mesh-like support having a porosity greater than about 85%.

28. The reactor of claim 1 further comprising:
f) a furnace which produces a flue gas containing nitrogen oxide; and,
g) a conduit for conveying the flue gas from the furnace to the gas stream inlet of the shell.

29. A method for the selective catalytic reduction of nitrogen oxide in a gas which comprises:
a) introducing a reducing agent into a gas stream containing nitrogen oxide;
b) in a first heating step, passing the gas stream with the reducing agent through a heat exchanger;
c) in a second heating step, raising the temperature of the gas stream with the reducing agent to a reaction temperature sufficient for the catalyzed reduction of nitrogen oxide with the reducing agent;
e) passing the gas stream with the reducing agent through a catalyst bed containing at least one nitrogen oxide conversion catalyst effective for the selective catalytic reduction of nitrogen oxide in the presence of the reducing agent to produce a treated gas; and,
f) passing the treated gas through the heat exchanger to transfer heat from the treated gas to the gas stream with the reducing agent.

30. The method of claim 29 wherein the heat exchanger comprises a plurality of tubes and the first heating step comprises passing the gas steam radially outward through the heat exchanger across the tubes, the step of passing the gas stream through the catalyst bed comprises passing the gas stream axially through the catalyst bed, and the step of passing the treated gas through the heat exchanger comprises passing the treated gas through the tubes.

31. The method of claim 29 wherein the heat exchanger comprises a plurality of tubes and the first heating step comprises passing the gas steam radially outward through the heat exchanger across the tubes, the step of passing the gas stream through the catalyst bed comprises passing the gas stream radially inward through the catalyst bed, and the step of passing the treated gas through the heat exchanger comprises passing the treated gas through the tubes.

32. The method of claim 29 wherein the heat exchanger comprises a plurality of tubes and the first heating step comprises passing the gas steam radially inward and then radially outward through the heat exchanger across the tubes, the step of passing the gas stream through the catalyst bed comprises passing the gas stream axially through the catalyst bed, and the step of passing the treated gas through the heat exchanger comprises passing the treated gas through the tubes.

33. The method of claim 29 wherein the heat exchanger comprises a plurality of tubes and the first heating step comprises passing the gas steam radially inward and then radially outward through the heat exchanger across the tubes, the step of passing the gas stream through the catalyst bed comprises passing the gas stream radially inward through the catalyst bed, and the step of passing the treated gas through the heat exchanger comprises passing the treated gas through the tubes.

34. The method of claim 29 wherein the heat exchanger comprises a plurality of tubes and the first heating step comprises passing the gas steam through the tubes, the step of passing the gas stream through the catalyst bed comprises passing the gas stream axially through the catalyst bed, and the step of passing the treated gas through the heat exchanger comprises passing the treated gas radially outward through the heat exchanger across the tubes.

35. The method of claim 29 wherein the heat exchanger comprises a plurality of tubes and the first heating step comprises passing the gas steam through the tubes, the step of passing the gas stream through the catalyst bed comprises passing the gas stream radially inward through the catalyst bed, the step of passing the treated gas through the heat exchanger comprises passing the treated gas radially outward through the heat exchanger across the tubes.

36. The method of claim 29 wherein the heat exchanger comprises a plurality of tubes and the first heating step comprises passing the gas steam through the tubes, the step of passing the gas stream through the catalyst bed comprises passing the gas stream axially through the catalyst bed, and the step of passing the treated gas through the heat exchanger comprises passing the treated gas radially outward and then radially inward through the heat exchanger across the tubes.

37. The method of claim 29 wherein the heat exchanger comprises a plurality of tubes and the first heating step comprises passing the gas steam through the tubes, the step of passing the gas stream through the catalyst bed comprises passing the gas stream radially inward through the catalyst bed, and the step of passing the treated gas through the heat exchanger comprises passing the treated gas radially outward and then radially inward through the heat exchanger across the tubes.
